(19) United States
(12) Patent Application Publication
(10) Pub. No.: US 2007/0209899 A1
(43) Pub. Date: Sep. 13, 2007

(54) Decoupling vibration isolator

(76) Inventors: Keming Liu, Sterling Height, MI (US); Yahya Hodjat, Oxford, MI (US); Marc R. Cadarette, London (CA); Lin Zhu, Rochester Hills, MI (US); Yuding Feng, Rochester Hills, MI (US)

Correspondence Address: Jeffrey Thurnau;The Gates Corporation, MS: IP Law Dept. 10-A3, 1551 Wewatta Street, Denver, CO, 80202, US

(21) Appl. No.: 11/371,581

(22) Filed: Mar. 9, 2006

(51) Int. Cl. F16D 23/00

(52) U.S. Cl. 192/55.2

(57) ABSTRACT

A decoupling vibration isolator comprising a driver member, a driven member, a retaining member immovably attached to the driver member and having a sliding engagement with the driven member to allow predetermined rotational movement of the driven member with respect to the driving member, an energy absorbing member disposed between the driver member and the driven member, the energy absorbing member compressed between the driver member and the driven member in a driving direction, and the driven member temporarily decoupleable from the driver member by decompression of the energy absorbing member whereby substantially no torque is transmitted from the driver member to the driven member for a predetermined angular range.

### FIELD OF THE INVENTION

The invention relates to a decoupling vibration isolator, and more particularly to decoupling vibration isolator temporarily decoupleable from a driver member by decompression of an energy absorbing member whereby substantially no torque is transmitted from the driver member to a driven member for a predetermined angular range.

### BACKGROUND OF THE INVENTION

Vibration damping apparatuses are conventionally used on the drive line of motor vehicles, for example on the engine crank. Known apparatuses for this purpose are constituted by rubberlike or flexible couplings and correspond to a sleeve spring coupling, which is also known as an elastic spring.

In the case of such apparatuses, there is a disk-like or annular elastic body, generally a rubber body between the cylindrical surfaces of in each case directly coupled between one outer and one inner torsionally stiff part. The (rubber) elastic body is generally stressed under tangential couple during all modes of operation. The elastic body, which can also be in the form of several parts, absorbs the torsional vibrations of the part to be damped, in this case normally a drive line.

The damping of the torsional vibrations also results from the rotary movement between the damping mass constructed as a ring and the inner drive part, the damping mass and hardness of the elastic body having to be matched to one another in order to achieve a damping in the case of a desired vibration frequency.

Torsional vibrations are excited by periodic fluctuations of the torques from a prime mover, for example as a result of the firing events of an internal combustion engine.

Representative of the art is U.S. Pat. No. 4,355,990 to Duncan (1982) which discloses a torsionally elastic power transmitting device rotatable about an axis, and having a hub member provided with at least two lugs, a rim member disposed outwardly of the hub provided with at least two ears matingly engaging the lugs in torsional driving relation, and resilient cushion spring means interposed between the ears and lugs to transmit power therebetween. The improvement is directed to the use of hub and rim members having along their respective outer and inner peripheries a plurality of juxtaposed radial bearing surfaces of substantial axial dimension, and in substantial mutual contact with one another. In use, there is thus provided a large radial bearing surface with the hub and rim members of the torsionally elastic device tending to automatically self-align and maintain concentricity.

What is needed is a decoupling vibration isolator temporarily decoupleable from a driver member by decompression of an energy absorbing member whereby substantially no torque is transmitted from the driver member to a driven member for a predetermined angular range.

### SUMMARY OF THE INVENTION

The primary aspect of the invention is to provide a decoupling vibration isolator temporarily decoupleable from a driver member by decompression of an energy absorbing member whereby substantially no torque is transmitted from the driver member to a driven member for a predetermined angular range.

Other aspects of the invention will be pointed out or made obvious by the following description of the invention and the accompanying drawings.

The invention comprises a decoupling vibration isolator comprising a driver member, a driven member, a retaining member immovably attached to the driver member and having a sliding engagement with the driven member to allow predetermined rotational movement of the driven member with respect to the driving member, an energy absorbing member disposed between the driver member and the driven member, the energy absorbing member compressed between the driver member and the driven member in a driving direction, and the driven member temporarily decoupleable from the driver member by decompression of the energy absorbing member whereby substantially no torque is transmitted from the driver member to the driven member for a predetermined angular range.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front perspective view of the pulley.

FIG. 2 is a front perspective view of the pulley including the elastomeric members.

FIG. 3 is a front perspective view of the crank flange.

FIG. 4 is a front perspective view of the crank flange including the elastomeric members.

FIG. 5 is a front perspective cut away view of the assembled decoupling vibration isolator.

FIG. 6 is a front perspective view of the decoupling vibration isolator.

FIG. 7 is a side perspective cut away view of the assembled decoupling vibration isolator.

FIG. 8 is a front perspective cut away view of the decoupling vibration isolator with a belt engaged.

FIG. 9 is a cross-sectional view of the inventive damper isolator in FIG. 8.

FIG. 10 is a graph of the relationship between torque and angular displacement for the decoupling vibration isolator.

FIG. 11 is a graph of the crank relationship between rotary speed and time.

FIG. 12 is a perspective view of an alternate embodiment.

FIG. 13 is a cross sectional view of the alternate embodiment in FIG. 12.

FIG. 14 is an exploded perspective view of an alternate embodiment.

FIG. 15 is an exploded perspective view of the alternate embodiment in FIG. 14.

FIG. 16 is a cross-sectional view of the embodiment in FIG. 14.

FIG. 17 is an exploded perspective view of an alternate embodiment.

### DETAILED DESCRIPTION OF THE PREFERRED EMBODIMENT

The inventive decoupling vibration isolator tunes an engine belt drive system to have its first resonance frequency below the engine firing frequency at its idle speed. Therefore, there is no resonance of angular vibration for the belt drive in the whole rpm range of engine operation. However, during start-up of the engine, when the engine speeds up from 0 rpm and goes through the reduced (tuned) system frequency, there will be a transient resonance of the belt drive which may generate belt slip noise “chirp”. In prior art cases, a decoupling device such as alternator one-way-clutch (OWC) has to be implemented. In the instant invention a predetermined gap is implemented between each pair of elastomer elements.

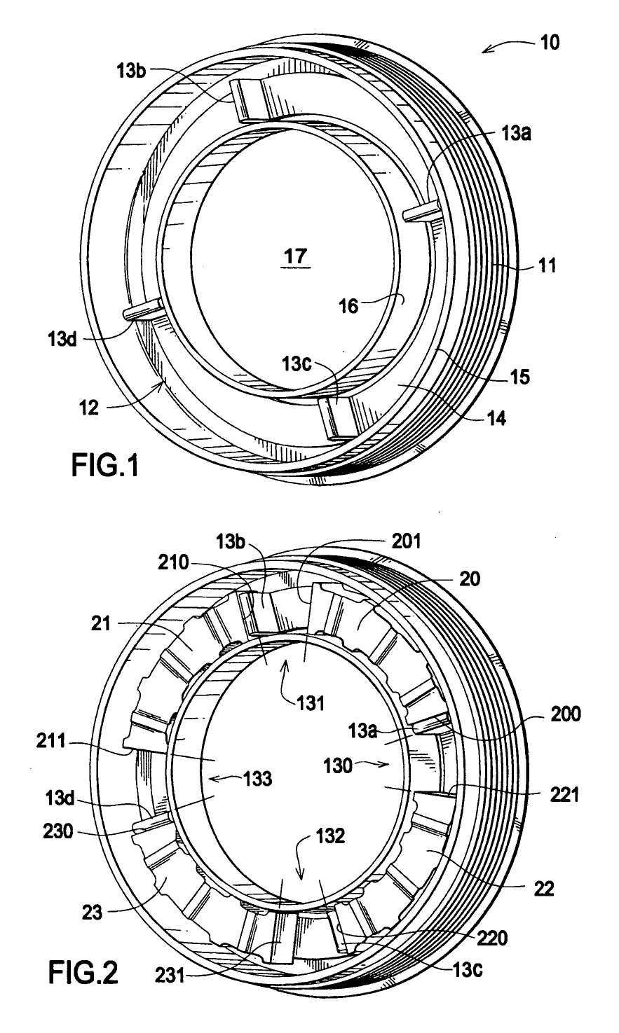

FIG. 1 is a front perspective view of the pulley. The inventive decoupling vibration isolator comprises a pulley 10. Pulley 10 comprises an outer belt engaging surface 11. Belt engaging surface 11 comprises a multi-ribbed profile. Pulley 10 further comprises an inner annular space 12. Annular space 12 is defined by outer portion 15 and inner portion 16, and radial web portion 14. Substantially planar tabs 13a, 13b, 13c, 13d are attached to radial web portion 14 and project into annular space 12. Inner portion 16 describes a hole 17.

FIG. 2 is a front perspective view of the pulley including the elastomeric members. Elastomeric members 20, 21, 22, 23 are disposed within annular space 14. Elastomeric members 20, 21, 22, 23 have an arcuate shape that substantially matches the curvature of annular space 14.

The elastomeric members 20, 21, 22, 23 comprise materials known in the art, including EPDM, HNBR, CR, natural and synthetic rubbers and combinations of two or more of the foregoing. Each is compressible. Each comprises a substantially linear spring rate. Each elastomeric member also has a damping characteristic or damping rate (μ) known in the art.

Each elastomeric member 20, 21, 22, 23 has an end 200, 210, 220, 230, respectively, that in turn engages a respective tab 13a, 13b, 13c, and 13d respectively. In this embodiment each elastomeric member 20, 21, 22, 23 has a length that is less than the spacing between each tab 13a, 13b, 13c, 13d.

Each elastomeric member 20, 21, 22, 23 has an arcuate, circumferential length of approximately 70°. This circumferential length is not limiting and is only offered as an example. The circumferential spacing between tabs 13a, 13b, 13c, 13d is approximately 90°. Hence, a gap 130, 131, 132, 133 of approximately 20° exists between each tab and the end of an adjacent elastomeric member. For example, gap 130 is disposed between end 221 and tab 13a. Likewise, gap 131 is disposed between end 201 and tab 113b. Gap 132 is disposed between end 231 and tab 13c. Gap 133 is disposed between end 211 and tab 13d.

Each gap allows the driven pulley 10 to temporarily decouple from the driver crank flange 50 during periods of deceleration of driver crank flange 50. The decoupling is accomplished in part by the relative movement between 10 and 50 allowed by each gap. Namely, when crank flange 50 is transmitting power to pulley 10 each elastomeric member is compressed causing a corresponding slight decrease in length. When the crank flange 50 is not transmitting power to pulley 10, each elastomeric member expands or decompresses on release of the compressive force to a slightly longer uncompressed length. The expansion is facilitated by each gap 130, 131, 132, 133 which allows relative rotational movement of the pulley 10 with respect to crank flange 50 to occur. Each energy absorbing member is unloaded, that is fully decompressed, in order to achieve decoupling, namely, each energy absorbing member does not experience a tensile load during operation. Please note that decoupling does not occur at all magnitudes of driver member decelerations. Free overrun (decoupling) of the driven member accessory components occurs when the inertia torque in the reversal direction is equal to the torque being transmitted. In other words, decoupling depends on two factors, 1) the driven member load torque being transmitted, and 2) the moments of inertia of all driven member components. Decoupling may occur under a low rate of deceleration if the driven member component torque loads are low and driven member inertias are high, and vise versa.

The numeric, dimensional information provided herein is for the purpose of illustration only and is not intended to be limiting in terms of dimensions that may be required to provide a decoupling vibration isolator for a specific application.

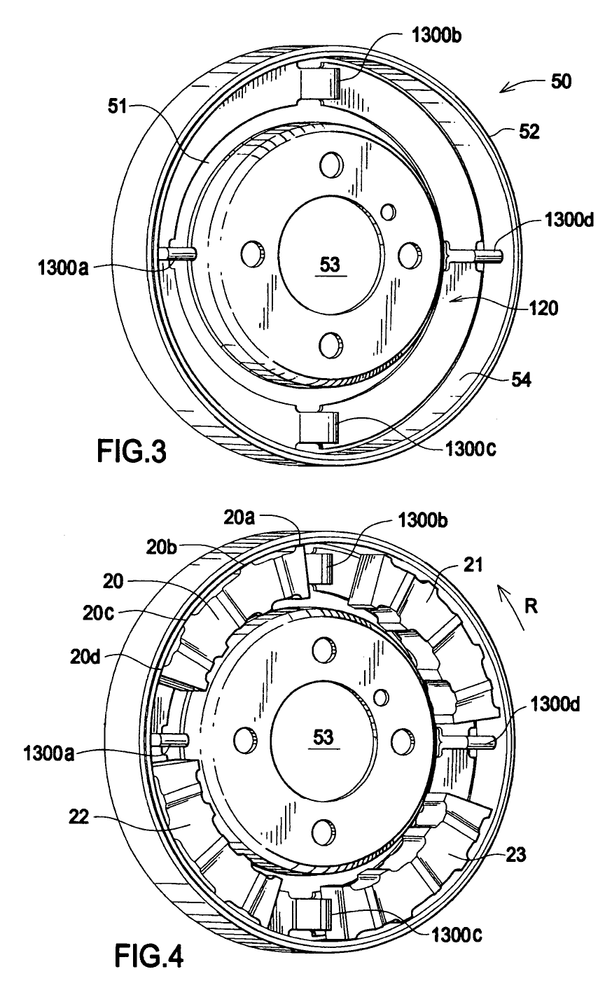

FIG. 3 is a front perspective view of the crank flange. Crank flange 50 is normally connected to an engine crank (not shown). Crank flange 50 comprises a radial web portion 51 and an outer portion 52. Substantially planar tabs 1300a, 1300b, 1300c, 1300d are attached to radial web portion 51 and project into annular space 120. Hole 53 is disposed in web portion 51. The spacing between tabs 1300a, 1300b, 1300c, 1300d is approximately 90°.

A low friction surface 54 is disposed on the radially inward portion of outer portion 52. Low friction surface 54 allows sliding movement of elastomeric member 20, 21, 22, 23. The frictional coefficient of surface 54 may be adjusted to alter or adjust damping of relative movement between pulley 10 and crank flange 50.

FIG. 4 is a front perspective view of the crank flange including the elastomeric members. Each tab 1300a, 1300b, 1300c, 1300d is disposed in a respective gap 130, 131, 132, 133. Each elastomeric member further comprises ribs, for example, ribs 20a, 20b, 20c, 20d on elastomeric member 20, to reduce the total surface contact between low friction surface 54 and the elastomeric member. The ribs also allow the elastomeric member to expand somewhat under compression in annular space 14.

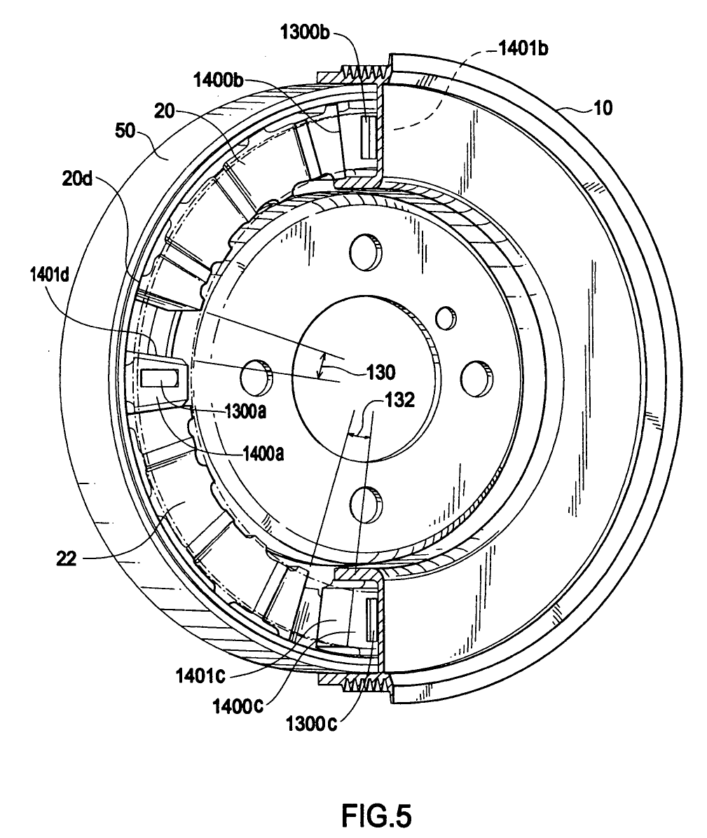

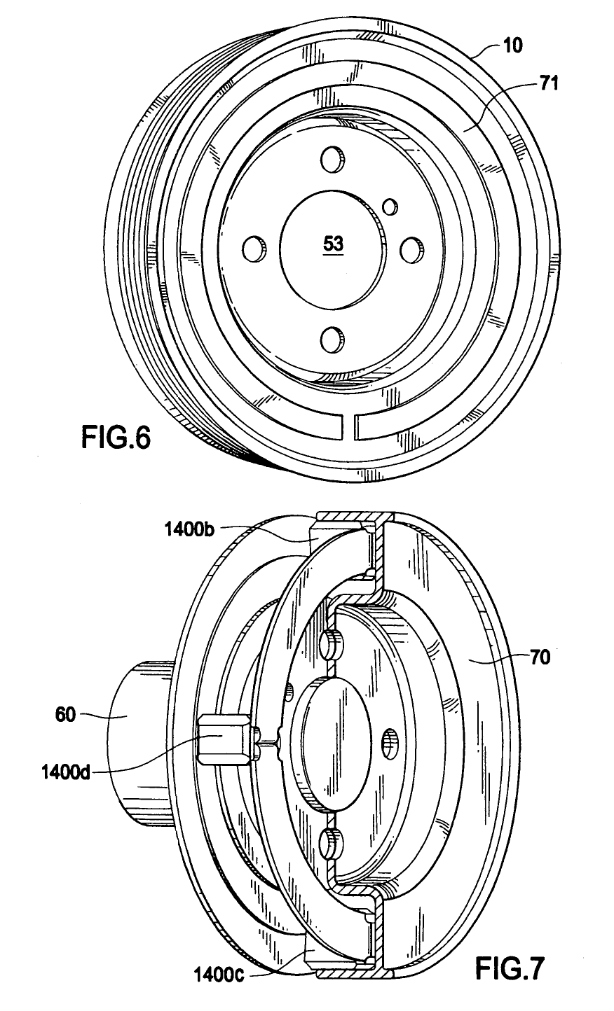

FIG. 5 is a front perspective cut away view of the assembled decoupling vibration isolator. Pulley 10 is engaged over and crank flange 50. Crank flange 50 is nested within annular space 12 of pulley 10.

Cap 1400d is engaged over tab 1300d. Cap 1400c is engaged over tab 1300c. Cap 1400b is engaged over tab 1300b. Cap 1400a (not shown) is engaged over tab 1300a (not shown).

Once assembled, elastomeric member 20 is captured between tab 13a and cap 1400b. Elastomeric member 22 is captured between tab 13c and cap 1400a. There is no gap disposed on either end of any elastomeric member. Hence, each of the gaps is disposed between adjacent tabs that project from the pulley 10 and the crank flange 50. Namely, gap 130 is disposed between tab 13a and tab 1300a. Gap 131 is disposed between tab 13b and tab 1300b. Gap 132 is disposed between tab 13c and tab 1300c. Gap 133 is disposed between tab 13d and tab 1300d.

Caps 1400a, 1400b, 1400c, 1400d comprise any suitable elastomeric material known in the art, including EPDM, HNBR, CR, natural and synthetic rubbers and combinations of two or more of the foregoing. The width of each gap 130, 131, 132, 133 is reduced by the thickness of each cap 1400a, 1400b, 1400c, 1400d respectively. For example, gap 130 is disposed between tab 13a and end 221 of elastomeric member 22, said gap having its arcuate length (i.e. width) reduced by the arcuate length (i.e. thickness) of cap 1400a on tab 1300a. Consequently, the arcuate length of gap 130, and of gaps 131, 132, 133 since all are of substantially equal size, is in the range of approximately 5° to approximately 10°. One can appreciate that the width of gaps 130, 131, 132, 133 need only be sufficient to allow an approximately 3° to approximately 5° relative rotation of pulley 10 with respect to flange 50 in order to absorb a momentary angular deceleration during operation.

A belt B engages belt engaging surface 11. Belt B may be a v-ribbed belt or v-belt, each known in the art.

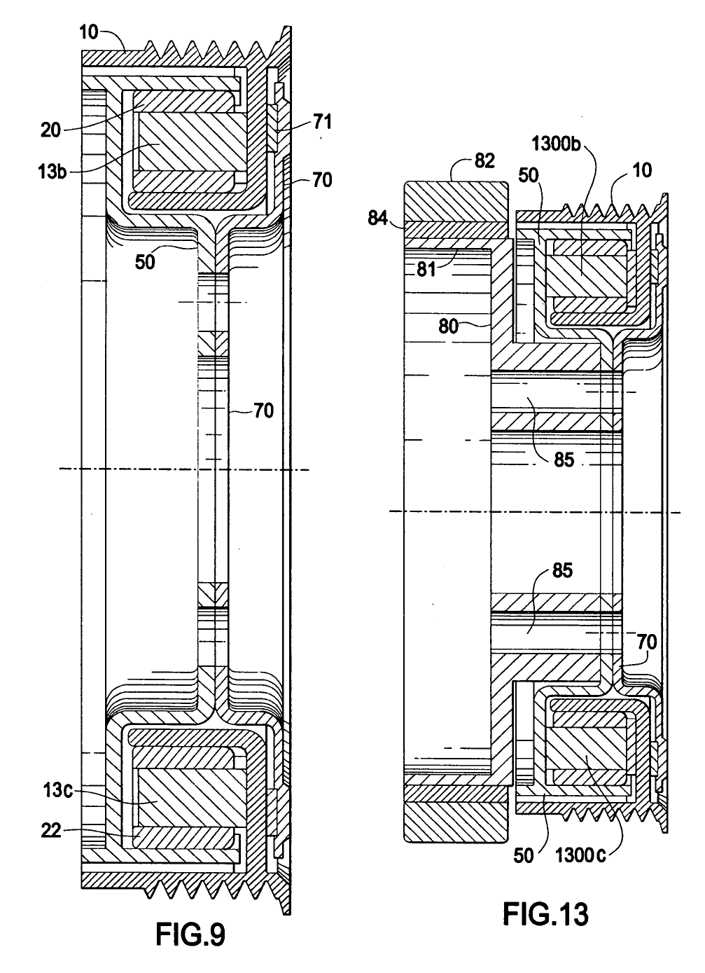

FIG. 6 is a front perspective view of the decoupling vibration isolator. Crank flange 50 is nested within annular space 12 of pulley 10. Low friction strip 71 allows relative rotational movement of pulley 10 with respect to cap 70, see FIG. 9.

FIG. 7 is a side perspective cut away view of the assembled decoupling vibration isolator. Caps 1400b, 1400c and 1400d are shown without the elastomeric members 20, 22. Hub 60 engages an engine crankshaft (not shown). Cap 70 retains pulley 10 within crank flange 50.

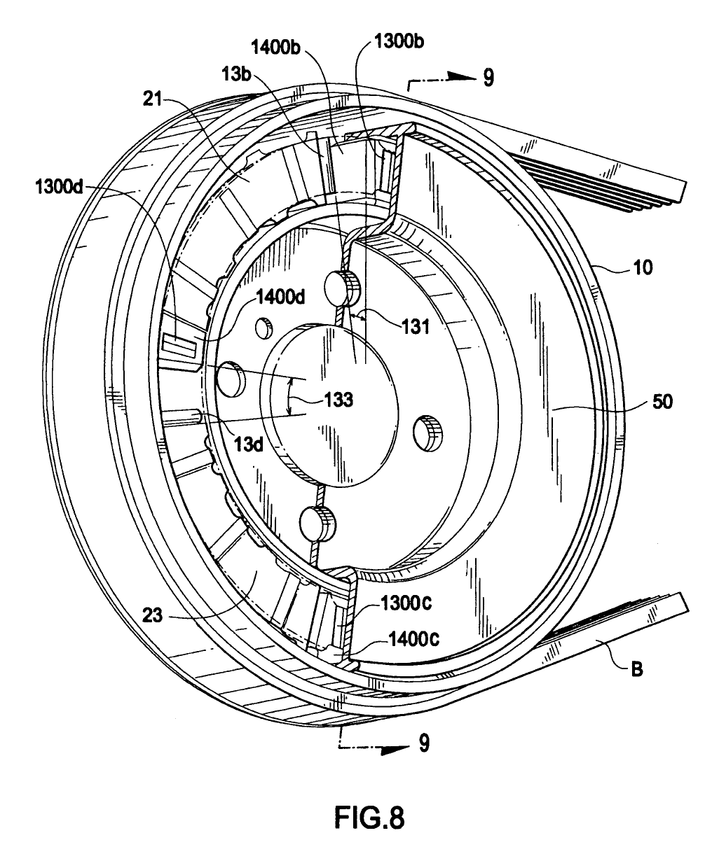

FIG. 8 is a front perspective cut away view of the decoupling vibration isolator with a belt engaged. A belt B is shown engaged with pulley 10. Gap 133 between tab 13d and cap 1400d is clearly shown. Elastomeric member 21 is disposed between tab 13b and tab 1300d, with cap 1400d. Elastomeric member 23 is disposed between tab 13d and tab 1300c, with cap 1400c.

FIG. 9 is a cross-sectional view of the inventive damper isolator in FIG. 8. Cap 70 is spot welded to flange 50 in order to hold pulley 10 in proper relation with flange 50, namely, pulley 10 is captured between cap 70 and flange 50. Cap 70 is slidingly engaged with the pulley 10 to allow a relative rotational movement of the pulley 10 with respect to the flange 50. Low friction strip 71 facilitates relative rotational movement between cap 70 and pulley 10 by reducing friction between the parts, see also FIG. 6.

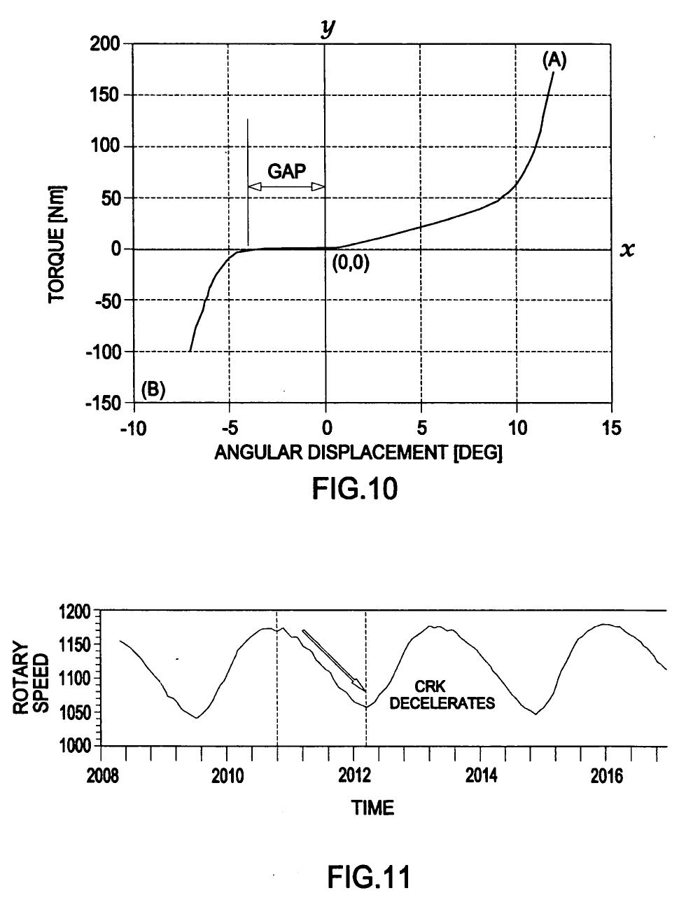

FIG. 10 is a graph of the relationship between torque and angular displacement for the decoupling vibration isolator. At coordinate (0,0) each end of elastomeric member 20, 21, 22, 23 is fully engaged with cap 1400b, 1400d, 1400a, 1400c and tabs 13a, 13d, 13c, 13d. The decoupling vibration isolator is driven in direction “R” as shown in FIG. 4. As the torque transmitted increases in the belt driven system, the angular displacement, or relative angular position of pulley 10 with respect to the flange 50 increases, namely, the elastomeric members 20, 21, 22, 23 are slightly compressed allowing the crank flange 50 to angularly advance with respect to the pulley 10. This is depicted by the curve in quadrant “A”.

When the crankshaft of the engine has a momentary angular deceleration of high magnitude, the gaps decouple the elastomeric member from the tabs, thereby decoupling the inertia of all driven belt driven engine accessories from the crank, thus reducing the system vibration. The effect of the gaps is shown as well as the torque reversal in quadrant “B”. The gap represents the relatively unrestricted relative rotation of the pulley 10 with respect to the crank flange 50 during the momentary angular decelerations of crank flange 50. Namely, the gap comprises a predetermined angular range of movement wherein substantially no torque is transmitted between the crank flange 50 and the pulley 10, hence temporarily decoupling the driver from the driven. If the angular deceleration is of sufficient magnitude, the pulley tabs engage the elastomeric caps in a manner that cushions the over-rotation to reduce or eliminate any effect of unrestrained lash.

During periods of operation, namely, accelerations when the flange is driving the pulley, the elastomeric members 20, 21, 22, 23 function as energy absorbing members to damp impulses caused by the firing events, thereby minimizing transmission of damaging impulses to the engine accessories. This is also the case during periods of deceleration, namely, the elastomeric members by virtue of their compressibility absorb impulses to minimize the magnitude and duration of impulses that would otherwise be transmitted through the belt drive system.

FIG. 11 is a graph of the crank relationship between rotary speed and time. Since the subject invention is used on an internal combustion engine, each firing event causes an impulse that is transmitted through the crankshaft to the accessories driven by the belt drive. Each pulse causes the crankshaft to accelerate and then decelerate. These pulses are absorbed by the inventive decoupling vibration isolator to minimize the magnitude and duration of the pulses being transmitted to the accessory drive belt accessories. This enhances the operating life of the belt as well as the accessories.

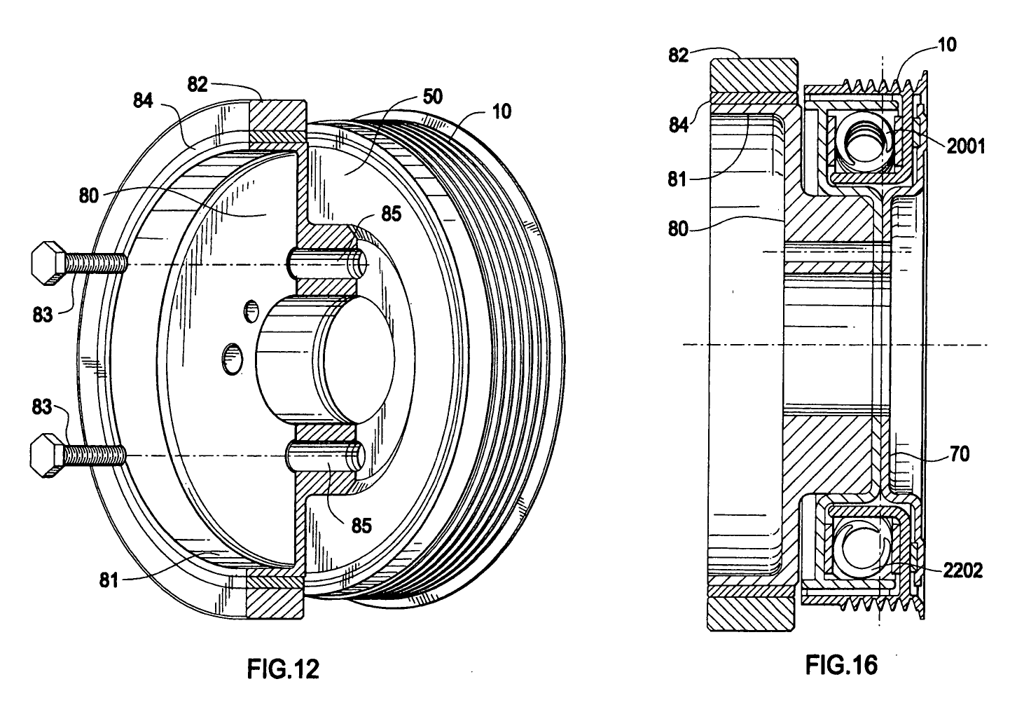

FIG. 12 is a perspective view of an alternate embodiment. In the case of internal combustion engines, the end of the crankshaft transfers power to the accessory belt drive system. The crankshaft usually goes through torsional vibrations with frequencies of about 250 hertz to 500 hertz, caused by the engine cylinder firing events. If the amplitude of the torsional vibration is high (higher than about 0.5 degrees) a crank damper may be used to absorb the vibration energy of the torsional vibration of the crankshaft. Otherwise the crankshaft may fail due to fatigue. Noise may also be generated. In addition, there is also an angular vibration generated in the crankshaft by the fact that firing of cylinders is a discontinuous, intermittent process. The angular vibration is more pronounced at lower engine rpm's and is at a much lower frequency, at approximately 20 to 30 hertz with amplitudes of about one degree or greater. Although this vibration can be damped, the damping requires a very high mass inertial member, which mass requirement is not practical from an engine design point of view. Consequently, to prevent the adverse effects of the angular vibration on the engine accessories, the angular vibration is isolated from the accessory drive by use of a crankshaft damper.

Damper hub 80 is connected to flange 50 by known means, including bolts 83 installed through holes 85. Damper hub 80 may also be spot welded to flange 50. Damper hub 80 comprises an outer circumferential surface 81. Surface 81 has a width that extends in an axial direction.

An elastomeric member 84 is disposed between surface 81 and inertial member 82. Elastomeric member 84 is compressed between surface 84 and inertial member 82 to a compressed thickness that is approximately 70% to approximately 95% of an uncompressed thickness. Inertial member 82 comprises a mass that when combined with the elastomeric member 84 are sufficient to damp torsional and lateral crank vibrations. The inventive decoupling vibration isolator may be used with or with out the inertial mass 82 and elastomeric member 84 described in FIG. 12.

Elastomeric member 84 comprises a damping characteristic (μ). Damping characteristic (μ) is selected in order for member 84 to damp vibrations, oscillations and any other relative movement between hub 80 and inertial member 82 as may be required by the service. Bolts 83 may also be used to attach the device to an engine crankshaft (not shown).

The elastomeric member 84 comprises materials known in the art, including EPDM, HNBR, CR, natural and synthetic rubbers and combinations of two or more of the foregoing.

FIG. 13 is a cross sectional view of the alternate embodiment in FIG. 12. FIG. 13 depicts the device in FIG. 9 with the exception that the damping portion described in FIG. 12 is attached to crank flange 50.

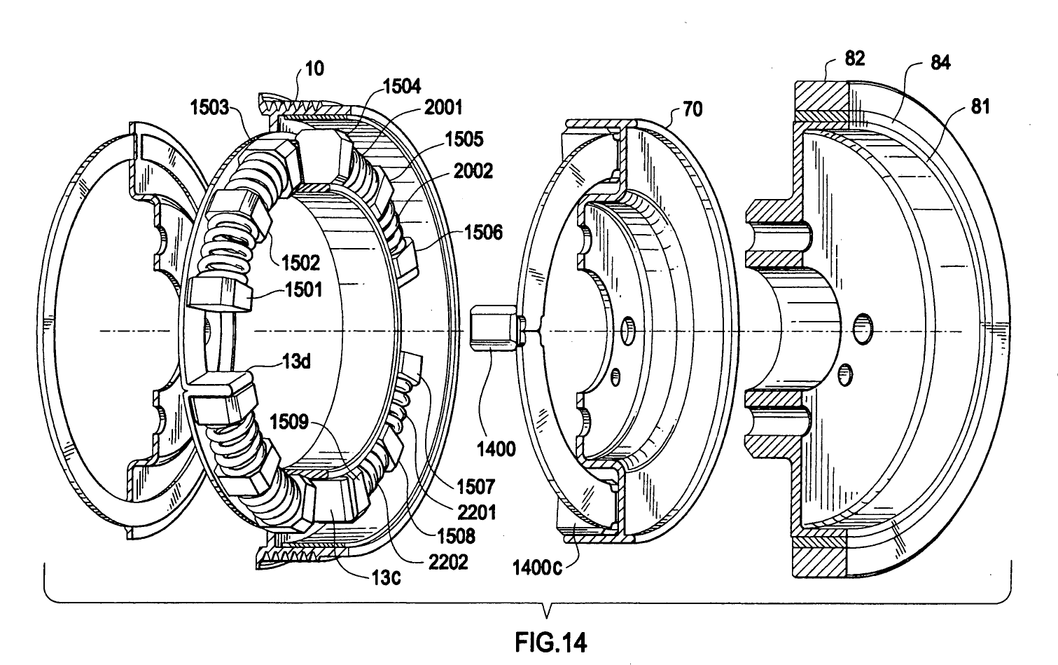

FIG. 14 is an exploded perspective view of an alternate embodiment. In this alternate embodiment elastomeric members 20, 21, 22, 23 are replaced with corresponding spring member pairs. The spring members are 2001, 2002, 2101, 2102, 2201, 2202, 2301, 2302, and each are disposed in annular space 14 at a substantially constant radius. The spring member pairs are 2001, 2002; 2101, 2102; 2201, 2202; 2301, 2302.

Disposed between each pair of spring members is a member 1502, 1505, 1508, 1511, respectively. Each member 1502, 1505, 1508, 1511 operates to properly align and retain in position an end of each adjacent spring within annular space 14. For example, ends of springs 2101 and 1202 are engaged with member 1502. This alternating “stacked” arrangement allows use of springs that do not have an excessive length which may otherwise cause the spring to buckle or distort in the annular space under compressive loading.

Hence, an assembly comprising 2101, 2102, 1501, 1502, 1503 is used in this embodiment instead of elastomeric member 21. An assembly comprising 2001, 2002, 1504, 1505, 1506 is used in this embodiment instead of elastomeric member 20. An assembly comprising 2201, 2202, 1507, 1508, 1509 is used in this embodiment instead of elastomeric member 22. An assembly comprising 2301, 2302, 1510, 1511, 1512 is used in this embodiment instead of elastomeric member 23.

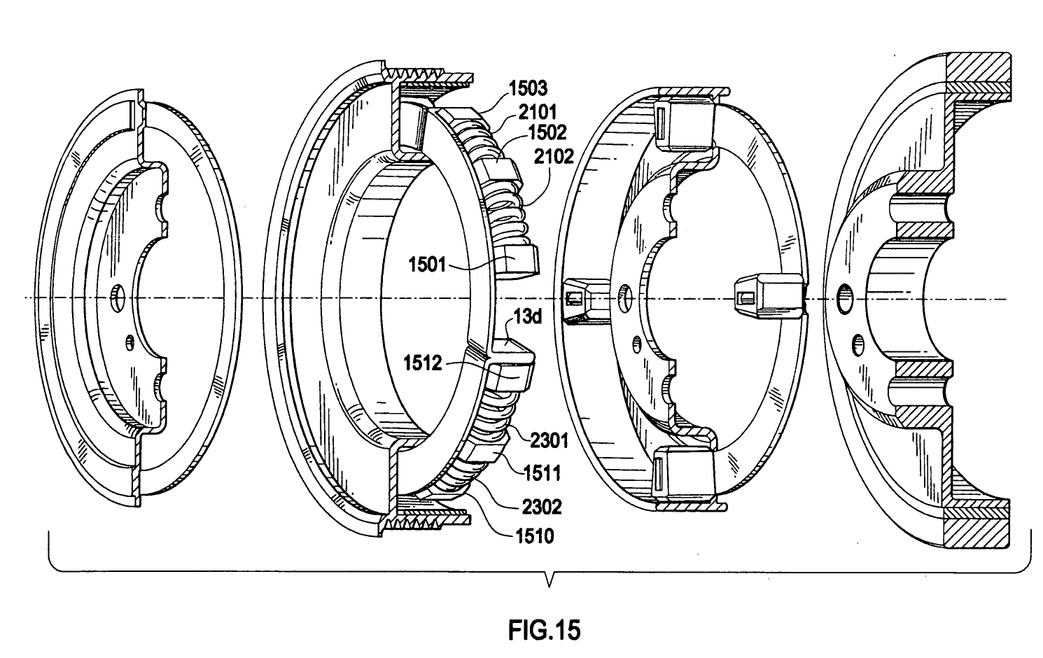

FIG. 15 is an exploded perspective view of the alternate embodiment in FIG. 14. Each spring is a cylindrical helical coil spring that comprises a spring rate (k). The spring rate for each spring may be substantially linear or variable as is known in the art. Each spring assembly, comprises two springs as described, the springs arranged in series where the total spring rate is, for example:
k₁(total)=(1/k₂₀₀₁+1/k₂₀₀₂)⁻¹
The total spring rate for the damper is determined as a function of each of the four spring assemblies arranged in parallel where the total spring rate is:
k_{Total}=k₁(total)+k₂(total)+k₃(total)+k₄(total)
The size and spring rate for each spring is selected based upon the amplitude and frequency of the pulse to be damped.

The length of each spring in each pair of springs is selected to allow each spring assembly (as described herein) to occupy the space between the tabs on pulley 10 and crank flange 50 as elsewhere described for the elastomeric members, see FIG. 8.

FIG. 16 is a cross-sectional view of the embodiment in FIG. 14. Springs 2001 and 2202 are shown disposed within annular space 14. The diameter for all springs is slightly less than the width of the annular space in order to minimize side to side displacement of each spring when each spring is under compression.

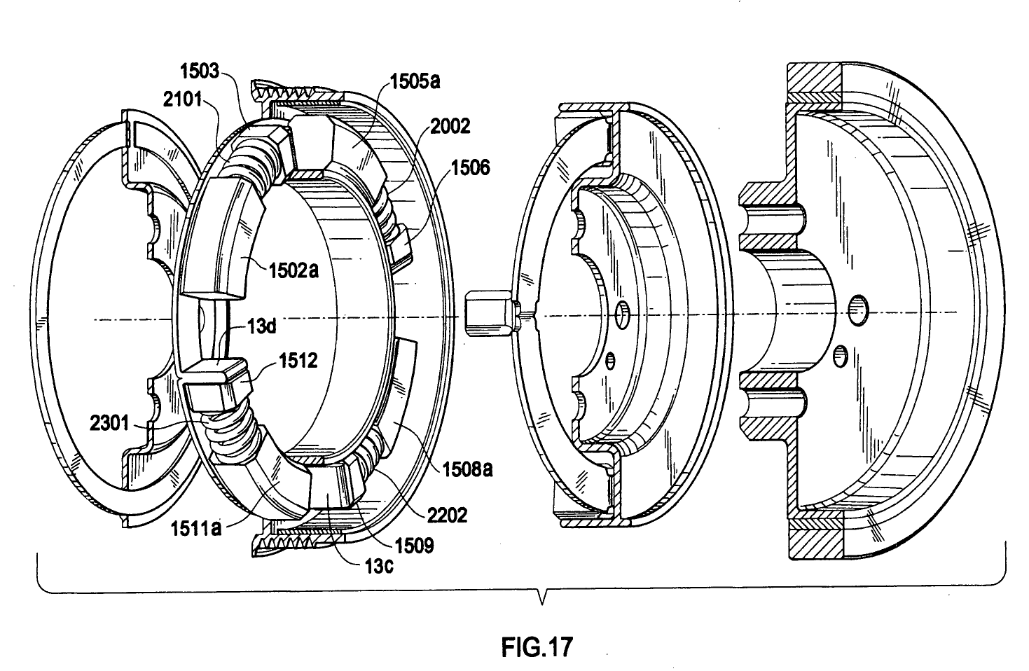

FIG. 17 is an exploded perspective view of an alternate embodiment. The embodiment in FIG. 17 is the same as that described in FIGS. 14 and 15 with the following exceptions. In this embodiment a single spring is used instead of a spring pair as in FIG. 15. For example, spring 2102 and member 1501 are replaced by a single member 1502a. Likewise, spring 2001 and member 1504 are replaced by a single member 1505a. Spring 2201 and member 1507 are replaced by a single member 1508a. Spring 2302 and member 1510 are replaced by a single member 1511a. Springs 2101, 2002, 2202, and 2301 each comprise a predetermined spring rate in accordance with operating conditions.

In yet another alternate embodiment, and in order to achieve a variable overall spring rate, each spring can be given a spring rate that differs from the spring rate for the other springs. This alternate embodiment is available for any of the foregoing embodiments. In this embodiment the springs exert a spring force related to the torque applied, but in a variable manner causing a predetermined angular rotation between pulley 10 and the crank flange 50 that was variable depending upon the torque being applied by the driving member.

This embodiment provides another level of adjustability to the device by allowing yet another combination of springs, ands thereby, spring rate.

Although forms of the invention have been described herein, it will be obvious to those skilled in the art that variations may be made in the construction and relation of parts without departing from the spirit and scope of the inventions described herein.

We claim:

1. A decoupling vibration isolator comprising:
a driver member;
a driven member;
a retaining member immovably attached to the driver member and having a sliding engagement with the driven member to allow predetermined rotational movement of the driven member with respect to the driving member;
an energy absorbing member disposed between the driver member and the driven member, the energy absorbing member compressed between the driver member and the driven member in a driving direction;
the driven member temporarily decoupleable from the driver member by decompression of the energy absorbing member whereby substantially no torque is transmitted from the driver member to the driven member; and
a gap disposed between the driver member and the driven member for allowing a relative rotational movement between the driver member and the driven member upon a driver member deceleration.

2. The decoupling vibration isolator as in claim 1 further comprising a friction member disposed between the driven member and the retaining member.

3. The decoupling vibration isolator as in claim 1, wherein:
the energy absorbing member comprises an elastomeric material; and
the energy absorbing member is disposed in a annular space in the driven member.

4. The decoupling vibration isolator as in claim 1, wherein the energy absorbing member comprises ribs disposed about an outer surface of the energy absorbing member.

5. The decoupling vibration isolator as in claim 1, wherein:
the driver member transmits a torque to the driven member in a first rotational direction; and
wherein substantially no torque is transmitted between the driver member and the driven member upon a temporary deceleration of the driver member.

6. The decoupling vibration isolator as in claim 1 further comprising:
an inertial member engaged with the driver member; and
an elastomeric member disposed between the inertial member and the driver member.

7. The decoupling vibration isolator as in claim 6, wherein the inertial member is engaged to the driver member by a hub.

8. The decoupling vibration isolator as in claim 1, wherein the energy absorbing member comprises a spring.

9. The decoupling vibration isolator as in claim 1, wherein the energy absorbing member comprises a plurality of springs in parallel.

10. The decoupling vibration isolator as in claim 1, wherein the energy absorbing member comprises at lease one pair of springs connected in series.

11. The decoupling vibration isolator as in claim 1, wherein the driven member comprises a ribbed profile.
